(19) United States
(12) Patent Application Publication
(10) Pub. No.: US 2026/0044064 A1
(43) Pub. Date: Feb. 12, 2026

(54) PROJECTION-TYPE VIDEO DISPLAY DEVICE

(71) Applicant: Panasonic Projector & Display Corporation, Osaka (JP)

(72) Inventors: Shigekazu YAMAGISHI, Osaka (JP); Yuki YAMAGATA, Osaka (JP)

(21) Appl. No.: 19/360,251

(22) Filed: Oct. 16, 2025

Related U.S. Application Data
(63) Continuation of application No. PCT/JP2024/015551, filed on Apr. 19, 2024.

(30) Foreign Application Priority Data
Apr. 21, 2023 (JP) 2023-070100

(51) Int. Cl. G03B 21/28

(52) U.S. Cl. CPC G03B 21/28

(57) ABSTRACT

A projection-type video display device includes a light source, an image display element, a projection lens, a reflection prism, and a reflection surface. The image display element generates ON light modulated as video light by reflecting source light from the light source at a first angle and OFF light as unnecessary light by reflecting the source light at a second angle. The projection lens projects the ON light. The reflection prism guides the source light to the image display element and guides the ON light modulated by the image display element to the projection lens. The reflection surface guides the OFF light in an opposite direction to the projection lens with respect to an ON light emitting surface to the projection lens included in the reflection prism.

### CROSS REFERENCE TO RELATED APPLICATION

This is a continuation application of International Application No.PCT/JP2024/015551, with an international filing date of April 19, 2024, which claims priority of Japanese Patent Application No.2023-070100 filed on April 21, 2023, the content of which is incorporated herein by reference.

### BACKGROUND

### TECHNICAL FIELD

The present invention relates to a projection-type video display device using a reflective image display element.

In related art, a projection-type video display device using a reflective image display element modulates strong light from a light source for each of pixels two-dimensionally arranged in an effective screen by the image display element which is a light valve, and enlarges and projects the modulated light on a screen by a projection lens. In the projection-type video display device, each pixel of the image display element is a micromirror, and an inclination direction is controlled according to an input video signal to modulate input light.

Here, ON light in a case where the micromirror is in an inclined state, here, a first inclined state, is guided to an optical path to the screen a video light, but OFF light in a case where the micromirror is in a second inclined state is not guided to the projection lens as unnecessary light, enters a light absorbing member in another optical path, is absorbed, and becomes heat.

In this event, a temperature of the light absorbing member becomes high, and thus, scorching that heats a member disposed in the vicinity of the light absorbing member to a high temperature occurs. Thus, a large-scale device has been provided such as providing a cooling member in order to ensure reliability. In particular, in recent years, increase in luminance (increase in output) of the projection-type video display device is progressing, and a problem that the temperature of the light absorbing member becomes high becomes remarkable. In addition, the OFF light is emitted while spreading, and thus, it is necessary to arrange the light absorbing member and the cooling member having a size capable of covering an irradiation range of the OFF light in the vicinity of the optical member from which the OFF light is emitted, and it is difficult to secure a space for arrangement.

For example, in JP 2000-10045 A, in order to eliminate stray light and improve contrast, an air layer is provided between an image display element and a total reflection prism at an angle at which illumination light and ON light are transmitted and OFF light is reflected. According to this, the OFF light is not emitted to the projection lens side, and thus, it is effective in terms of increasing a degree of freedom in arrangement of the light absorbing member.

In addition, in JP 2000-206610 A, a prism having a high refractive index is attached to an optical path of OFF light of a total reflection prism, and the OFF light is guided to a direction other than an attachment surface by using a refractive index difference. As a result, it is possible to prevent the OFF light from returning to the total reflection prism and to prevent decrease in contrast due to stray light in the projected image.

### SUMMARY

### Problems to be Solved by the Invention

However, in the projection-type display device of JP 2000-10045 A, the air layer is obliquely provided between the image display element and the reflection prism, and thus, a size of the prism disposed between the projection lens and the image display element is increased, and a size of the projection lens is increased. Furthermore, there is a concern that increase in the air layer on the optical path of the ON light has a negative effect such as flare on the projected image.

In addition, in an optical system of JP 2000-206610 A, the OFF light is guided in a projection direction of the ON light as illustrated in the drawing, and thus, the OFF light guided in the projection direction needs to be processed by the light absorbing member, and the light absorbing member disposed near the projection lens generates heat. In addition, in a case where the optical system of JP 2000-206610 A is used in a high-output projection-type video display device, there is a concern that heat generation and thermal expansion of the high refractive index prism due to internal absorption due to repeated circulation of OFF light in the high refractive index prism to be attached may occur, and the total reflection prism to be attached may be adversely affected.

An object of the present disclosure is to provide a projection-type video display device in which thermal influence of OFF light by an image display element on a periphery of an ON light incident side of a projection lens is reduced and increase in size is suppressed.

### Solutions to the Problems

A projection-type video display device according to the present disclosure includes: a light source; an image display element that generates ON light modulated as video light by reflecting source light from the light source at a first angle and OFF light as unnecessary light by reflecting the source light at a second angle; a projection lens that projects the ON light; a reflection prism that guides the source light to the image display element and guides the ON light modulated by the image display element to the projection lens; and a reflection surface that guides the OFF light in an opposite direction to the projection lens with respect to an ON light emitting surface to the projection lens included in the reflection prism.

Another projection-type video display device according to the present disclosure includes a light source, a plurality of image display elements that modulates light from the light source into video light, a projection lens that projects the video light, a color prism that guides the light from the light source to the plurality of image display elements and guides the light modulated by the image display elements to the projection lens, and a reflection prism that is disposed between the projection lens and the color prism and guides the light from the light source to the color prism. The image display elements generate ON light modulated as video light by being reflected at a first angle and OFF light as unnecessary light by being reflected at a second angle. A reflection surface that guides the OFF light in an opposite direction to the projection lens with respect to a surface of the color prism facing the reflection prism is provided.

### Effects of the Invention

The present disclosure can provide a projection-type video display device in which thermal influence of OFF light by an image display element on a periphery of an ON light incident side of a projection lens is reduced and increase in size is suppressed.

### BRIEF DESCRIPTION OF THE DRAWINGS

FIG. 1 is a view illustrating a configuration of a projection-type video display device according to a first embodiment;

FIG. 2 is a view taken along a line II-II in FIG. 1;

FIG. 3 is a view illustrating a configuration of an optical device as a comparative example;

FIG. 4 is a view illustrating a first modification of the first embodiment;

FIG. 5 is a view illustrating a second modification of the first embodiment;

FIG. 6 is a view illustrating a third modification of the first embodiment;

FIG. 7 is a peripheral view of a projection lens of the projection-type video display device equipped with an optical configuration according to the first embodiment;

FIG. 8 is a view illustrating a configuration of an optical device according to a second embodiment;

FIG. 9 is a perspective view illustrating a prism configuration of an optical configuration according to the second embodiment;

FIG. 10 is a top view illustrating a prism configuration of the optical configuration according to the second embodiment;

FIG. 11 is a view illustrating a first modification of the optical configuration of the second embodiment;

FIG. 12 is a perspective view illustrating the first modification of the optical configuration of the second embodiment;

FIG. 13 is a view illustrating a second modification of the optical configuration of the second embodiment;

FIG. 14 is a perspective view illustrating the second modification of the optical configuration of the second embodiment;

FIG. 15 is a peripheral view of a projection lens of a projection-type video display device equipped with an optical device according to the second embodiment; and

FIG. 16 is a peripheral view of a projection lens of a projection-type video display device equipped with the second modification of the optical configuration of the second embodiment.

### DETAILED DESCRIPTION

Hereinafter, embodiments will be described in detail with reference to the drawings as appropriate. However, unnecessarily detailed description may be omitted. For example, detailed description of a well-known matter and repeated description of substantially the same configuration may be omitted. This is to avoid unnecessary redundancy of the following description and to facilitate understanding of those skilled in the art.

An optical/mechanism structure according to embodiments of the present disclosure will be described with reference to the drawings. The accompanying drawings and the following description are provided in order for those skilled in the art to fully understand the present disclosure and do not intend to limit the subject matter described in the claims by the accompanying drawings and the following description. Furthermore, in each drawing, each element is exaggerated in order to facilitate the description.

### (First Embodiment)

First, a projection-type video display device according to a first embodiment of the present disclosure will be briefly described. The projection-type video display device includes an optical mechanism that guides OFF light that is unnecessary light of a reflective image display element. In related art, OFF light is emitted to a surface of a prism disposed between the image display element and a projection lens, the surface facing the projection lens. By providing an OFF light emitting surface in the related art with a reflection function, it is possible to give a degree of freedom to an installation position of the light absorbing member that absorbs OFF light and generates heat, and it is possible to suppress radiation to the surroundings by the light absorbing member that becomes a high temperature, increase in stray light due to light that cannot be completely reflected, and the like. Note that in the following description, "video" includes "still image" and "moving image".

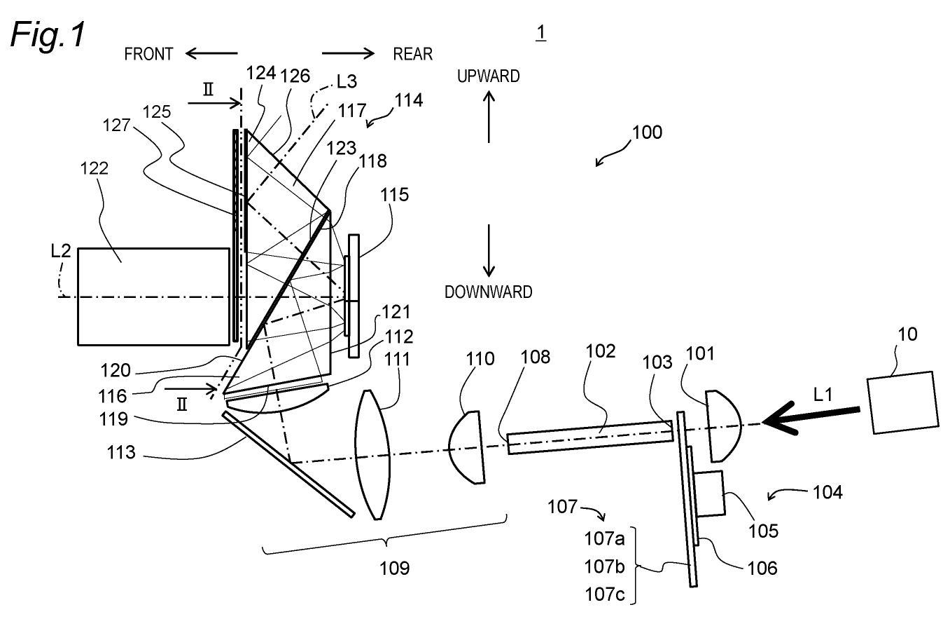

A projection-type video display device 1 according to the first embodiment of the present disclosure will be described with reference to FIG. 1. The projection-type video display device 1 includes a light source 10 and an optical configuration 100. Light source light L1 emitted from the light source 10 enters the optical configuration 100. The optical configuration 100 according to the first embodiment is a one-chip video projection optical configuration including one reflective image display element 115.

### [1-1. Description of Optical Configuration 100]

The light source light L1 emitted from the light source 10 is incident on a condenser lens 101 of the optical configuration 100. The condenser lens 101 condenses the light source light L1 on an incident surface 103 of a rod integrator 102 that is, for example, a glass quadrangular prism. A color wheel unit 104 is disposed between the condenser lens 101 and the rod integrator 102.

In the color wheel unit 104, a disk-shaped hub 106 extends to one side of a motor 105 rotatably attached to the center, and a color selection filter unit 107 is bonded and fixed thereto. The color selection filter unit 107 includes fan-shaped color selection filters 107a, 107b, and 107c. For example, the fan-shaped color selection filter 107a transmits only blue light of the incident light, the color selection filter 107b transmits only green light of the incident light, and the color selection filter 107c transmits only red light of the incident light.

The light source light L1 emitted from the light source 10 is incident on and transmitted through the fan-shaped color selection filter unit 107 to become each beam of color light and is sequentially guided to the rod integrator 102.

Emitted light from a light emitting surface 108 of the rod integrator 102 is incident on a relay optical system 109. The relay optical system 109 includes lenses 110, 111, 112, and a mirror 113, and guides the light from the rod integrator 102 to an effective display surface of the image display element 115 via a total reflection prism 114.

The total reflection prism 114 includes a prism 116 and a prism 117, and the prism 116 and the prism 117 are fixed while maintaining a gap 118 of several microns. The prism 116 and the prism 117 are made of optical glass. The light from the relay optical system 109 is incident on a first surface 119 of the prism 116 and then is incident on a second surface 120 of the prism 116 at an angle larger than the total reflection angle, so that the light is totally reflected and emitted from a third surface 121 of the prism 116. The third surface 121 faces the image display element 115.

The light transmitted through the third surface 121 of the prism 116 reaches an incident surface of the image display element 115. On the effective display surface of the image display element 115, minute mirrors are arranged in an array, and it is possible to perform drive control such that each mirror is inclined independently by an external signal. The inclination angle has two values, one of which reflects incident light a video light (ON light L2) incident on a projection lens 122, and the other of which reflects unnecessary light (OFF light L3) in a direction in which the light does not enter the projection lens 122. Note that the ON light L2 and the OFF light L3 illustrated in each drawing indicate the centers of the respective beams of light for easy viewing.

As described above, the ON light L2 reflected as the video light is transmitted through the third surface 121 of the prism 116 again and is incident on the second surface 120 of the prism 116, but the incident angle is smaller than the total reflection angle, and thus, the incident light on the second surface 120 of the prism 116 is transmitted through the second surface 120, passes through the gap 118, and is incident on the first surface 123 of the prism 117. The second surface 120 of the prism 116 and the first surface 123 of the prism 117 face each other with a gap 118 interposed therebetween.

The ON light L2 incident on the first surface 123 of the prism 117 is transmitted through the prism 117, reaches the second surface 124 of the prism 117 arranged in parallel with the third surface 121 of the prism 116, and is transmitted therethrough. Thus, the second surface 124 is the final ON light emitting surface of the total reflection prism 114 to the projection lens 122. Thereafter, the light enters the projection lens 122, and is guided onto a screen (not illustrated). Note that the projection lens 122 includes a plurality of lenses.

On the other hand, the OFF light L3 reflected as unnecessary light passes through the third surface 121 of the prism 116 again from the image display element 115, and is incident on the second surface 120 of the prism 116. Similarly to the video light, the incident angle is smaller than the total reflection angle, and thus, the OFF light L3 is transmitted through the second surface 120 of the prism 116, passes through the gap 118, and is incident on the first surface 123 of the prism 117.

The OFF light L3 is incident on the prism 117, then passes through the prism 117, and reaches the second surface 124 of the prism 117 arranged in parallel with the third surface 121 of the prism 116. Here, the reflection film 125 is provided in an incident region of the OFF light L3, and most of the incident OFF light L3 is reflected. The reflected OFF light L3 reaches the third surface 126 of the prism 117 and is transmitted therethrough. The reflection film 125 is formed with, for example, a vapor-deposited multilayer film, and heat due to reflection can be ignored.

As described above, the reflection film 125 can guide the OFF light L3 to the rear direction of a projection direction of the ON light L2, that is, in the opposite direction to the projection direction. Furthermore, the reflection film 125 guides the OFF light L3 in the opposite direction to the projection lens 122 with respect to the prism 117. As a result, a shutter 127 capable of blocking the ON light L2 to be projected can be disposed in the vicinity of the second surface 124 of the prism 117, for example, between the projection lens 122 and the total reflection prism 114 without concern of temperature rise due to heat absorption.

Note that, although simplified here, in a case where the shutter 127 does not allow slight light leakage at the time of black display in which the ON light L2 is not projected, the light reaching the projection lens 122 is mechanically blocked by an actuator not illustrated in FIG. 1, and electric components such as the actuator are required to suppress the temperature to a certain temperature. In addition to the shutter 127, a wobbling system for increasing resolution of the projected image may be disposed between the projection lens 122 and the total reflection prism 114.

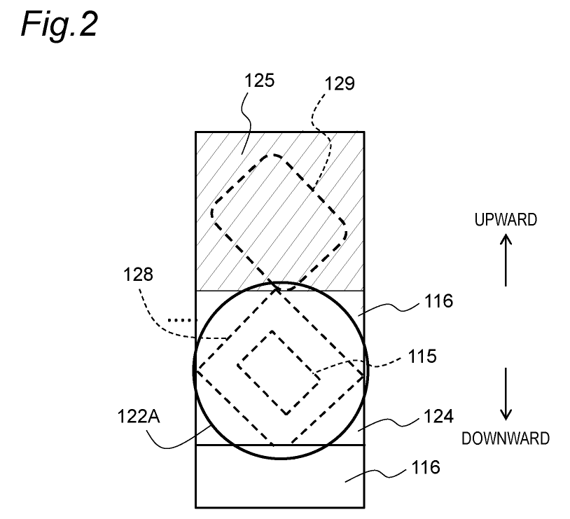

FIG. 2 is a view taken along a line II-II in FIG. 1, and is a view of the optical configuration 100 of the first embodiment as viewed from the front. In the following description, "front" is a light emitting direction of an optical axis of the projection lens 122, and "rear" is an opposite direction. In addition, "upward" is a direction of a component orthogonal to the optical axis of the projection lens 122 in a direction in which the source light L1 is incident on the total reflection prism 114, and "downward" is an opposite direction. FIG. 2 indicates an incident region of each of the ON light L2 and the OFF light L3 on the second surface 124 (ON light emitting surface) of the prism 117 with a dashed line, indicates an ON light incident region 128, and indicates an OFF light incident region 129. Further, hatching indicates a deposition position of the reflection film 125. When viewed from the light emitting side of the projection lens 122, the ON light incident region 128 is designed to be accommodated in a projection lens incident side opening 122A. Note that the ON light incident region 128 on the second surface 124 is also an ON light emission region.

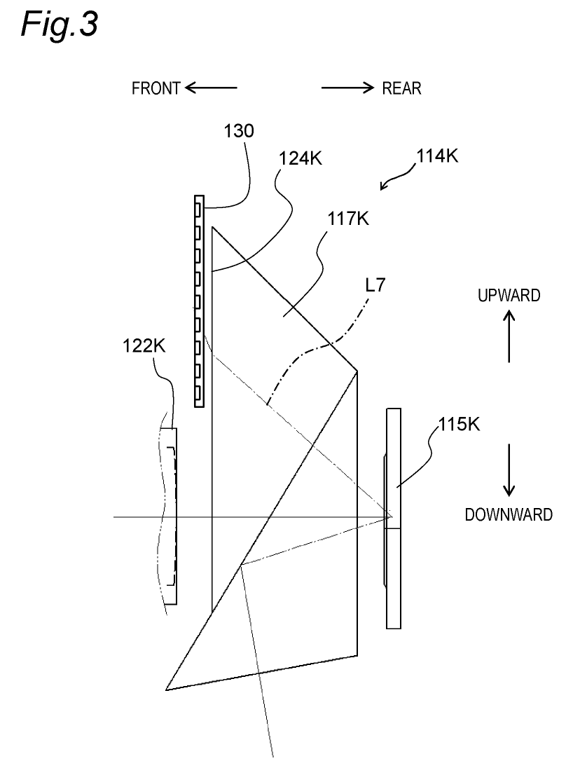

FIG. 3 illustrates a configuration example including a light absorbing plate 130 that absorbs the OFF light L7 as a comparative example, and the OFF light L7 emitted from an image display element 115K passes through a second surface 124K of a prism 117K and enters the light absorbing plate 130 that is a light absorbing member arranged at a constant interval on the front surface thereof. The light absorbing plate 130 is obtained by subjecting a heat conduction member such as copper or aluminum to blacking processing to provide light resistance, and in order to increase heat dissipation, as illustrated in FIG. 3, a convex portion that increases a surface area may be provided, and a dedicated heat dissipation fan may be provided as necessary. However, in particular, in a case of a high-output projection-type display device, a temperature of the OFF light incident portion greatly exceeds 100 degrees, and thus, it is difficult to arrange another member between the projection lens 122K in the vicinity of the OFF light incident portion and the second surface 124K of the prism 117K due to radiation heat of the light absorbing plate 130. As described above, this problem can be solved by the configuration described in the present embodiment.

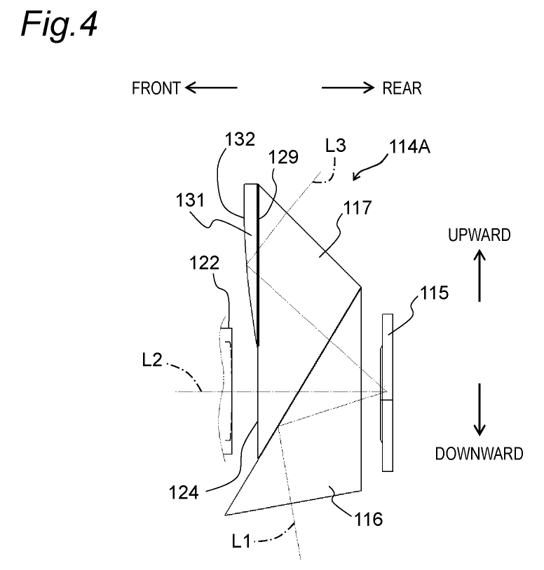

FIGS. 4 to 6 illustrate first to third modifications that exert similar effects. In the first modification illustrated in FIG. 4, in a total reflection prism 114A, a convex lens 131 is bonded to a position covering the OFF light incident region 129 on the second surface 124 of the prism 117. A light emitting surface 132 of the convex lens 131 is designed by setting an angle at which the incident OFF light L3 is totally reflected, and a reflection film, or the like, is not necessarily required for the light emitting surface 132, and the convex lens 131 can reflect the OFF light L3. There is no light absorption in the reflection film, and thus, excellent reflectance can be obtained, and the reflection effect can be achieved without concern of heat generation on the reflection surface.

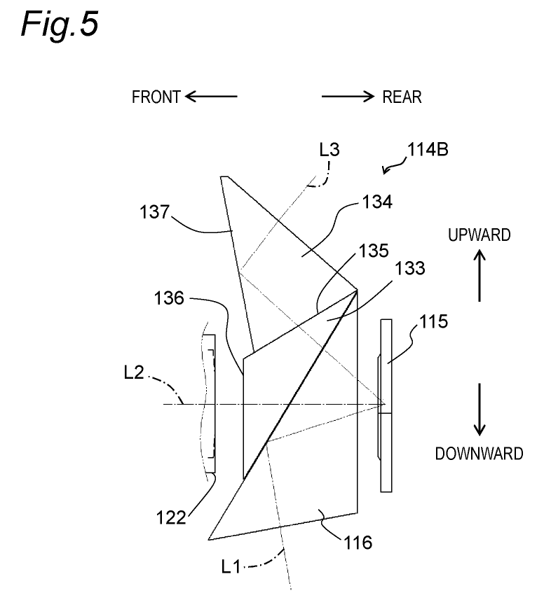

In the second modification illustrated in FIG. 5, the prism 117 is divided, and the total reflection prism 114B includes a first light emitting prism 133 through which the ON light L2 passes and a second light emitting prism 134 through which the OFF light L3 passes. These two prisms are in close contact with each other with a light transmissive adhesive to form a bonding surface 135. The OFF light L3 is transmitted through the first light emitting prism 133, the bonding surface 135, and the second light emitting prism 134, and reaches an inclined surface 137 inclined toward the projection lens 122 with respect to the light emitting surface 136 of the first light emitting prism 133 facing the projection lens 122. The inclined surface 137 is inclined in a direction in which the incident angle of the OFF light L3 increases as illustrated in FIG. 4, and the OFF light L3 is totally reflected here as in FIG. 4. The effects of the modification illustrated in FIG. 5 are similar to those of the modification of FIG. 4, and thus, are omitted. A lower end of the inclined surface 137 is located behind an upper end of the light emitting surface 136, and thus, an amount of forward protrusion of the inclined surface 137 can be reduced. Consequently, the inclined surface 137 can be prevented from abutting on a peripheral member of the projection lens 122 such as the shutter 127 due to forward inclination of the inclined surface 137.

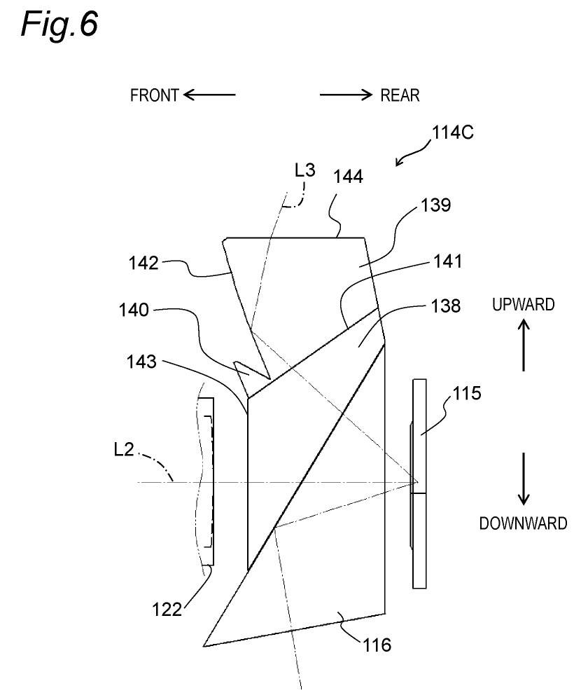

Further, in the third modification illustrated in FIG. 6, similarly to the second modification illustrated in FIG. 5, the prism 117 is divided, and the total reflection prism 114C includes a first light emitting prism 138 through which the ON light L2 passes and second light emitting prisms 139, 140 through which the OFF light L3 passes. As in the second modification illustrated in FIG. 5, bonding surfaces 141 exist between the first light emitting prism 138 and the second light emitting prism 139 and between the first light emitting prism 138 and the second light emitting prism 140.

By dividing the second light emitting prism in this way, even if a light emitting surface 142 of the second light emitting prism 139 protrudes toward the projection lens 122, it is possible to suppress an amount of forward protrusion with respect to the light emitting surface 143 of the first light emitting prism 138 facing the projection lens 122, and by covering the light emitting surface 143 side of an upper surface of the first light emitting prism 138 that cannot be covered by the second light emitting prism 139 with the second light emitting prism 140, it is possible to totally reflect all the OFF light L3 in a direction opposite to the projection direction without leakage.

A height of the second light emitting prism 140 is low as illustrated in FIG. 6, and thus, even if the second light emitting prism is inclined forward, a dimension of the second light emitting prism protruding forward can be suppressed. As described above, even in the modification illustrated in FIG. 6, the effects similar to those of the modification illustrated in FIG. 4 can be obtained using the total reflection of the OFF light L3.

Note that, in the first to third modifications illustrated in FIGS. 4 to 6, the convex lens 131 in FIG. 4, the second light emitting prism 134 in FIG. 5, and the second light emitting prisms 139, 140 in FIG. 6 do not have an influence on a projected video because light relating to actual projection does not pass therethrough, and may be made of a transparent material. Even if there is temperature increase due to absorption at the time of light transmission, radiation of the surrounding environment, heat conduction, and a volume change, it is also possible to obtain beneficial shape processability, weight, price, and the like, of the second light emitting prisms 139, 140 by using a transparent resin material that hardly generates stress in the first light emitting prisms 133, 138 made of optical glass.

Furthermore, by guiding the OFF light L3 passing through the second light emitting prism 139 upward after being totally reflected in a shape having a top surface 144 like the second light emitting prism 139, it is possible to give a further degree of freedom to the arrangement of surrounding components.

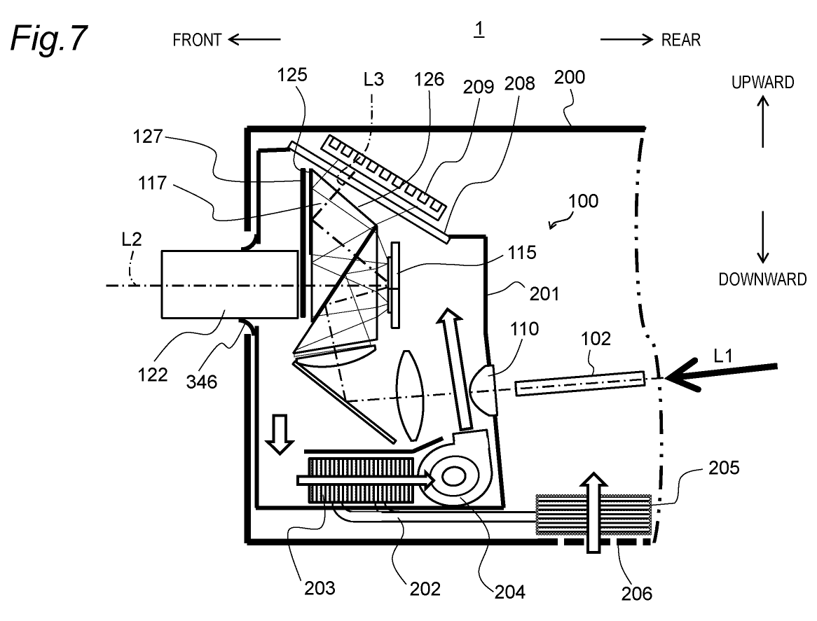

FIG. 7 illustrates a portion of the projection-type video display device 1 focusing on a peripheral configuration of the image display element 115 in FIG. 1. The projection-type video display device 1 includes an exterior case 200 and a sealed casing 201 that encloses the optical configuration 100 in a front portion of the exterior case 200. A heat receiving fin 203 and a circulation fan 204 are provided inside the sealed casing 201. The heat receiving fin 203 is connected to one of heat pipes 202 and is obtained by arranging fins made of thin plates in an overlapping manner. On a side opposite to the heat pipe 202 connected to the heat receiving fin 203, a heat radiating fin 205 obtained by arranging fins made of thin plates in an overlapping manner similarly to the heat receiving fin 203 is connected.

The heat radiating fin 205 is disposed in the exterior case 200 such that air from an outside air intake portion 206 in the exterior case 200 passes through the heat radiating fin 205. In the outside air intake portion 206, a vent hole is formed in a portion of the exterior case 200. The optical configuration 100 described with reference to FIG. 1 is installed in the sealed casing 201 as illustrated in FIG. 7, and the sealed casing 201 has a dustproof structure with the lens 110 that guides light to the optical configuration 100 and a buffer member 346 having no air permeability interposed around the projection lens 122 and a wall surface of the sealed casing 201 so that dust does not adhere to the optical member and the image display element from the outside.

Here, as described with reference to FIG. 1, the OFF light L3 from the image display element 115 is reflected by the reflection film 125 and is emitted from the third surface 126 of the prism 117 as the OFF light L3. The OFF light L3 is incident on a window 208 having a characteristic of transmitting the OFF light L3 disposed at a position facing the third surface 126 of the prism 117 of the sealed casing 201, and passes through the window 208. Further, the light absorbing plate 209 is disposed outside the sealed casing 201 in the vicinity of the window 208, has a characteristic of absorbing the OFF light L3, and has an uneven shape that increases a surface area for heat dissipation. Thus, the OFF light L3 transmitted through the window 208 is absorbed by the light absorbing plate 209 and becomes heat. However, the heat generation here is outside the sealed casing 201, so that it is possible to suppress increase in an internal temperature due to the OFF light processing of the sealed casing 201.

The ON light L2 is originally emitted from the projection lens 122, and thus, it is not always necessary to expect temperature rise in the sealed casing 201. Thus, the heat receiving fin 203, the circulation fan 204, the heat pipe 202, and the heat radiating fin 205, which are disposed in the sealed casing 201 and the exterior case 200 and are a portion of a cooling device that cools the sealed casing 201, can be changed to a small one or a heat sink having a simpler structure. As described above, according to the configuration of the modification illustrated in FIG. 7, it is possible to reduce a size and cost of a cooling member and a casing for accommodating the cooling member while maintaining reliability of the optical member and the image display element.

Note that the OFF light L3 is emitted from the third surface 126 of the prism 117 while spreading, and thus, as a distance between the third surface 126 of the prism 117 and the window 208 becomes closer, the sizes of the window 208 and the light absorbing plate 209 arranged in the vicinity of the window 208 can be made smaller. In addition, the window 208 may be formed by applying antireflection coating, or the like, to glass or a transparent resin, and fitting and fixing the glass or the transparent resin into the wall of the sealed casing 201 without any gap, or by molding the glass or the transparent resin into two colors with the sealed casing 201.

In addition, the light absorbing plate 209 is made of aluminum or copper having good thermal conductivity, and the light incident surface may be subjected to blacking processing, or the like, for suppressing reflection together with light absorption. In addition, in a case where an amount of light to be absorbed is large, air may be sent to an uneven portion on a back surface by a fan, or the like, to increase the heat dissipation effect. Furthermore, the light absorbing plate 209 can be also applied to a vapor chamber of a thin heat pipe, a cold plate through which a refrigerant liquid flows, and the like. In a case where heat is transferred and cooling processing is performed in another portion, the above-mentioned uneven shape is not necessarily required.

In FIG. 7, the optical configuration 100 of FIG. 1 is assumed, but the optical configurations illustrated in FIGS. 4, 5, and 6 can be replaced and are similarly effective. In FIGS. 4, 5, and 6, the OFF light L3 is returned by total reflection, and thus, the light reflected on the light emitting surface 132 of the convex lens 131, the inclined surface 137 of the second light emitting prism 134, and the light emitting surface 142 of the second light emitting prism 139, which are total reflection surfaces, has a large reflection angle and is guided in a direction close to the orthogonal direction with respect to the optical axis of the ON light L2, so that the window 208 and the light absorbing plate 209 are arranged in the upward direction of the sealed casing 201. In this case, a space is formed in the upward direction of the image display element 115, which is advantageous for arranging a drive circuit and a support member of the image display element 115.

### [1-2. Effects, and the like]

The projection-type video display device 1 of the first embodiment includes the light source 10, the image display element 115 that generates the ON light L2 modulated as video light by reflecting the light source light L1 from the light source 10 at a first angle and the OFF light L3 as unnecessary light by reflecting the light source light L1 at a second angle, the projection lens 122 that projects the ON light L2, and the total reflection prism 114 that guides the light source light L1 to the image display element 115 and guides the ON light L2 modulated by the image display element 115 to the projection lens 122. The projection-type video display device 1 further includes the second surface 124 on which the reflection film 125 is formed as a reflection surface that guides the OFF light L3 in the opposite direction to the projection lens 122. The second surface 124 is also the final ON light emitting surface to the projection lens 122 included in the total reflection prism 114, and the final ON light emitting surface and the reflection surface that guides the OFF light L3 in the opposite direction to the projection lens 122 have the same configuration.

The region on the second surface 124 where the reflection film 125 is formed acts as a reflection surface of the OFF light L3, and thus, the OFF light L3 emitted from the image display element 115 is incident on the reflection film 125 of the second surface 124, is reflected by the reflection film 125, and is guided in the opposite direction to the projection lens 122 with respect to the second surface 124 which is the final ON light emitting surface. As a result, it is possible to reduce temperature rise of the space in the vicinity of the second surface 124, which is also the final ON light emitting surface, due to the OFF light L3, and it is possible to reduce damage due to heat of the device such as the shutter 127. It is therefore possible to reduce the thermal influence of the OFF light L3 emitted from the image display element 115 on the periphery of the ON light incident side of the projection lens 122, to guide the OFF light L3 to a position where heat dissipation processing can be easily performed, and to enable the absorption processing, and to provide the projection-type video display device 1 that achieves high reliability. In addition, it is not necessary to add a dedicated prism for reflecting unnecessary light between the prism 116 and the image display element 115, and it is not necessary to provide an air layer between the dedicated prism and the prism 116. It is therefore possible to suppress increase in size of the total reflection prism 114 disposed between the projection lens 122 and the image display element 115, and it is possible to suppress increase in size of the optical configuration 100. Furthermore, by preventing increase in the air layer on the optical path of the ON light, it is possible to prevent increase in adverse effects such as flare of the projected image.

In addition, the reflection surface that reflects the OFF light L3 is configured such that the reflection film 125 as a member having a reflection effect on the OFF light L3 or a shape different from the region on which the ON light is emitted on the second surface 124 that is the ON light emitting surface or the light emitting surfaces 136, 143 is provided in the incident region 129 of the OFF light L3 not overlapping the incident region 128 of the ON light L2 on the second surface 124 that is the ON light emitting surface, or the inclined surface 137 as an extension portion extending from the light emitting surfaces 136, 143 that are the ON light emitting surfaces, and the incident region of the OFF light L3 of the second light emitting prism 140. As a result, the OFF light L3 can be accurately guided in the opposite direction to the projection lens 122.

The total reflection prism 114 is configured such that the OFF light L3 reflected by the reflection film 125 on the second surface 124 is emitted from the total reflection prism 114 in a direction intersecting with the ON light L2. As a result, a light emitting direction of the OFF light L3 can be moved away from a light emitting direction of the ON light L2.

In addition, the convex lens 131 as a light guide member that guides the OFF light L3, which is bonded to the total reflection prism 114A, is provided outside the optical path of the ON light L2 of the total reflection prism 114A, and the reflection surface that reflects the OFF light L3 is included in the convex lens 131 as a light guide member. With such a configuration, the OFF light L3 can be accurately guided in the opposite direction to the projection lens 122.

The total reflection prism 114B includes the first light emitting prism 133 that emits the ON light L2 to the projection lens 122 and the second light emitting prism 134 that emits the OFF light L3 in the opposite direction to the projection lens 122. The second light emitting prism 134 has an inclined surface 137 as a reflection surface, and the inclined surface 137 has an inclination inclined in a direction of increasing an incident angle with respect to the incident OFF light L3, and the OFF light L3 is totally reflected by this inclination. In addition, the second light emitting prism may be divided into two, and a total reflection prism 114C including the second light emitting prisms 139, 140 may be configured. With such a configuration, the OFF light L3 can be accurately guided in the opposite direction to the projection lens 122.

In addition, a material of the second light emitting prisms 134, 139, 140 is a transparent material having a refractive index the same as or lower than that of a material of the first light emitting prisms 133, 138.

Further, the projection-type video display device 1 includes the sealed casing 201 that includes the image display element 115, the total reflection prism 114, and an incident side portion of the ON light L2 in the projection lens 122. In the sealed casing 201, at least the window 208 as an incident region of the OFF light L3 emitted from the total reflection prism 114 has a characteristic of transmitting the OFF light L3. The OFF light L3 can be transmitted to the outside of the sealed casing 201 by the window 208, so that it is possible to reduce heating of the inside of the sealed casing 201 by the OFF light L3.

Further, the projection-type video display device 1 includes the light absorbing plate 209 as the light absorbing member disposed outside the sealed casing 201. The light absorbing plate 209 is disposed in the opposite direction to the projection lens 122 with respect to the reflection film 125 of the second surface 124 and on the optical path of the OFF light L3 emitted from the total reflection prism 114.

In recent years, in a case where the projection-type video display device is used in an environment with a lot of dust, or in a case where the projection-type video display device is used in a concert in which smoke is used for performance, fogging of optical components may be a problem. Fogging of the optical components can be reduced by accommodating a space between the projection lens 122 and the image display element 115 in the sealed casing 201 having a sealed structure. In addition, the light absorbing plate 209 is disposed outside the sealed casing 201, so that it is possible to reduce a heat transport amount for transporting heat inside the sealed casing 201 to the outside of the sealed casing 201 as compared with a case where a light absorbing material is disposed in the sealed casing 201. It is therefore possible to achieve downsizing and cost reduction of heat transport means such as a heat sink and a heat pipe for removing heat in the sealed casing 201 to the outside of the sealed casing 201.

### (Second Embodiment)

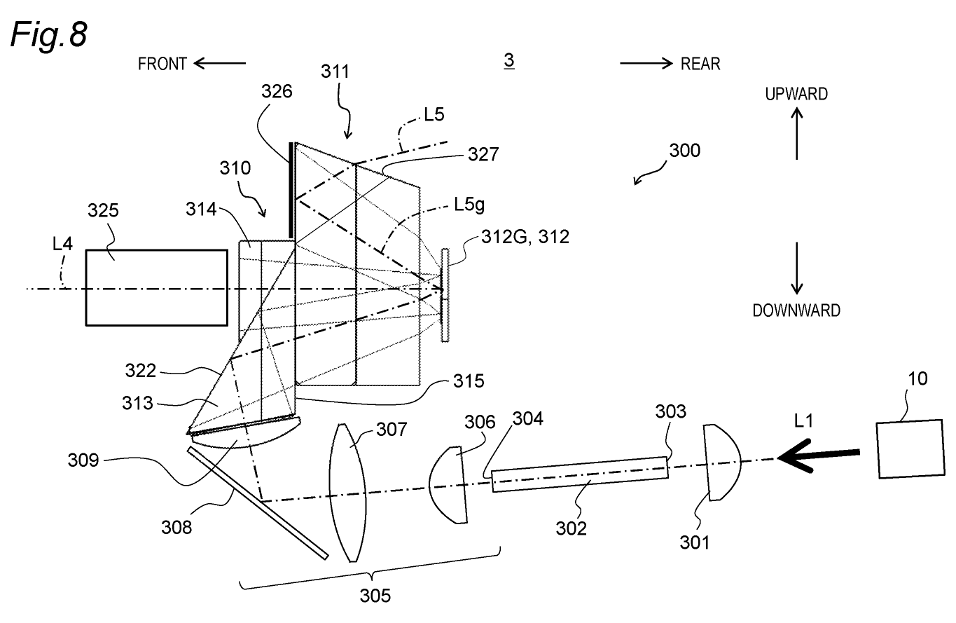

Next, a configuration example of a projection-type video display device 3 according to a second embodiment of the present disclosure will be described with reference to FIG. 8. An optical configuration 300 of the projection-type video display device 3 of the second embodiment includes three image display elements, and each image display element has a three-chip type configuration that modulates each color light. The projection-type video display device 1 of the first embodiment and the projection-type video display device 3 of the second embodiment have the same configuration except for this point and points described below, and thus, the description thereof will be omitted.

### [2-1. Description of Optical Configuration 300]

The source light L1 from the light source 10 is incident as indicated by an arrow in FIG. 8. A condenser lens 301 condenses the light source light L1 on an incident surface 303 of a rod integrator 302 which is a glass quadrangular prism. The light source light L1 is configured as white light.

The emitted light from a light emitting surface 304 of the rod integrator 302 is incident on a relay optical system 305. The relay optical system 305 includes lenses 306, 307, 309, and a mirror 308, and guides the light from the rod integrator 302 to an effective display surface of a reflective image display element 312 via a total reflection prism 310 and a color prism 311. The optical configuration 300 includes image display elements 312R, 312G, 312B that modulate the light divided into the red, blue, and green wavelength regions by the color prism 311. In a case where points common to the image display elements 312R, 312G, 312B are described, the image display elements 312R, 312G, 312B will be simply described as the image display element 312.

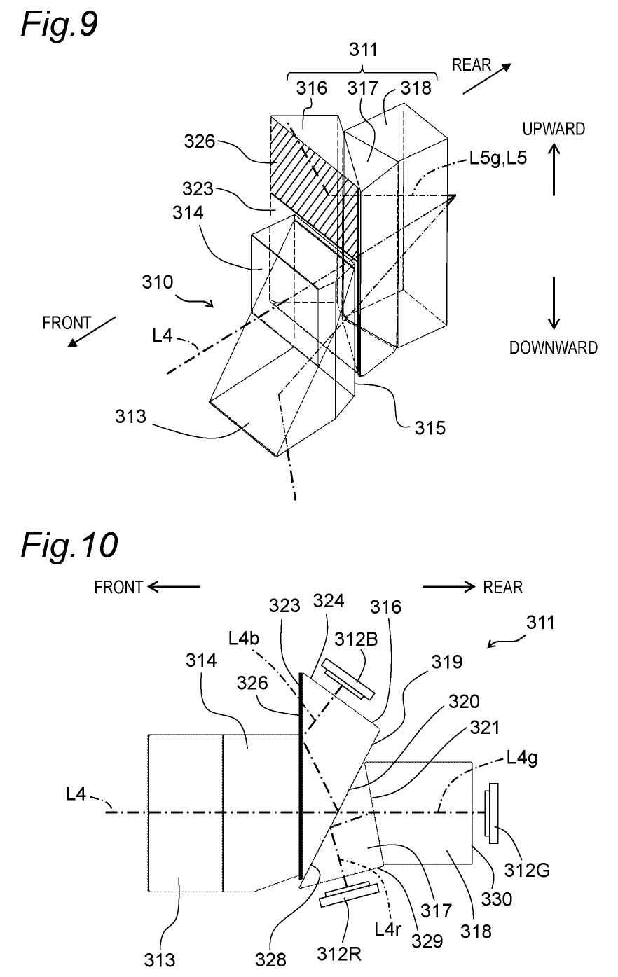

In particular, configurations of the total reflection prism 310 and the color prism 311 will be described with reference to FIGS. 9 and 10.

The total reflection prism 310 is configured by adhering and fixing a prism 313 and a prism 314 to each other while maintaining a gap of several microns in the same configuration as the total reflection prism 114 of the first embodiment described above, and thus, detailed description thereof will be omitted.

Light transmitted through a third surface 315 of the prism 313 is incident on the color prism 311. The color prism 311 includes a B prism 316, an R prism 317, and a G prism 318. In this example, a gap due to air is provided between the B prism 316 and the R prism 317 similarly to the total reflection prism 310, and the R prism 317 and the B prism 316 are bonded to each other. A blue reflection dichroic mirror 320 that reflects light of a blue wavelength is provided on a light selection surface 319 of the B prism 316, a red reflection dichroic mirror 321 is provided at an interface between the R prism 317 and the G prism 318, and the reflective image display elements 312R, 312G, 312B for respective color modulation are arranged facing the light emitting surfaces of the respective prisms.

The image display element 312 is the same element as the image display element 115, and thus, description thereof will be omitted. The image display element 312B generates blue ON light L4b and blue OFF light, the image display element 312R generates red ON light L4r and red OFF light, and the image display element 312G generates green ON light L4g and green OFF light L5g. ON light L4 obtained by combining the blue ON light L4b, the red ON light L4r, and the green ON light L4g is emitted from the color prism 311. In addition, in a case where points common to the blue OFF light, the red OFF light, and the green OFF light are described, the blue OFF light, the red OFF light, and the green OFF light will be simply described as the OFF light L5.

White light having passed through the relay optical system 305 is incident on the prism 313 of the total reflection prism 310, is totally reflected by the total reflection surface 322, is transmitted through the third surface 315 of the prism 313, and is incident on the B prism 316 of the color prism 311. Among the incident light incident on the B prism 316, the light in the blue wavelength region is reflected by the blue reflection dichroic mirror 320, totally reflected by a B prism front surface 323, and then emitted from a B prism facing surface 324 facing the image display element 312B to reach the image display element 312B.

The ON light L4b reflected as the video light by the image display element 312B passes through the B prism facing surface 324 again and is incident on the B prism front surface 323 again. The light is totally reflected by the blue reflection dichroic mirror 320, transmitted through the prism front surface 323, and emitted from the B prism 316 of the color prism 311 toward the projection lens 325. The emitted light is incident on the third surface 315 of the prism 313 of the total reflection prism 310, is incident on the total reflection surface 322 at a smaller incident angle than that when the emitted light is totally reflected first, is transmitted through the third surface 315, passes through the gap and the prism 314, is incident on the projection lens 325, and is guided onto a screen (not illustrated).

On the other hand, the OFF light reflected as unnecessary light by the image display element 312B also passes through the B prism facing surface 324 again and is incident on the B prism front surface 323 again. The OFF light is also totally reflected here, reflected by the blue reflection dichroic mirror 320, and reaches the prism front surface 323. A reflection film 326 is provided in the OFF light incident region of the prism front surface 323, and the incident light in the blue wavelength region is reflected here and reaches a top surface 327 of the color prism 311. The color prism 311 includes the B prism 316, the R prism 317, and the G prism 318, and thus, it means that their top surfaces form a continuous inclination as illustrated in FIG. 8. As illustrated in FIG. 8, the top surface 327 is inclined downward in a direction opposite to the projection direction so as not to be totally reflected when the OFF light L5 reflected by the reflection film 326 is incident. In this manner, the OFF light L5 of the light in the blue wavelength region is guided to the outside of the color prism 311.

Further, among the white light having passed through the relay optical system 305, the light in the red wavelength region is incident on the blue reflection dichroic mirror 320 similarly to the light in the blue wavelength region, passes through the blue reflection dichroic mirror 320, passes through the gap between the B prism 316 and the R prism 317, and is incident on the R prism 317. The red light incident on the R prism 317 is reflected by the red reflection dichroic mirror 321, totally reflected by the total reflection surface 328 of the R prism 317, emitted from the R prism facing surface 329 facing the image display element 312R, and reaches the image display element 312R.

The red ON light L4r reflected as red video light by the image display element 312R is transmitted through the R prism facing surface 329 again, and is incident on the total reflection surface 328 again. Here, the ON light L4r in the red wavelength region is totally reflected by the red reflection dichroic mirror 321, passes through the R prism 317, the gap between the B prism 316 and the R prism 317, and the B prism 316, and is superimposed on the same optical axis as the ON light L4b in the blue wavelength region. Thereafter, the light passes through the total reflection prism 310, enters the projection lens 325, and is guided onto a screen (not illustrated).

On the other hand, the OFF light reflected as unnecessary light in the red wavelength region by the image display element 312R also passes through the R prism facing surface 329 again, is reflected by the total reflection surface 328, is reflected by the red reflection dichroic mirror 321, passes through the gap between the B prism 316 and the R prism 317, and is incident on the B prism 316. Then, similarly to the OFF light in the blue wavelength region, the light reaches the prism front surface 323. Similarly, the light is reflected by the reflection film 326 of the prism front surface 323 and passes through the top surface 327 of the color prism 311.

Further, among the white light having passed through the relay optical system 305, the light in the green wavelength region passes through the blue reflection dichroic mirror 320 similarly to the light in the red wavelength region, passes through the gap between the B prism 316 and the R prism 317, enters the R prism 317, and enters the red reflection dichroic mirror 321. The light in the green wavelength region further passes through the red reflection dichroic mirror 321, enters the G prism 318, is emitted from the G prism facing surface 330 facing the image display element 312G, and reaches the image display element 312G.

The ON light L4g reflected as the video light in the green wavelength region by the image display element 312G passes through the G prism facing surface 330 again, sequentially transmits through the G prism 318, the R prism 317, and the B prism 316, and is superimposed on the same optical axis as the ON lights L4b and L4r in the blue and red wavelength regions. Thereafter, the light passes through the total reflection prism 310, enters the projection lens 325, and is guided onto a screen (not illustrated).

On the other hand, the OFF light L5g reflected as unnecessary light by the image display element 312G passes through the G prism 318, the R prism 317, and the B prism 316 again via the G prism facing surface 336, and reaches the prism front surface 323 similarly to the light in the blue and red wavelength regions. The light in the green wavelength region is also reflected by the reflection film 326 of the prism front surface 323 and passes through the top surface 327 of the color prism 311.

In this way, the projection-type video display device 3 according to the present embodiment can guide the respective beams of OFF light reflected by the image display elements 312R, 312G, 312B to the upward direction outside the color prism 311. By doing so, although not illustrated in the drawing, it is easy to install the light absorbing plate that absorbs each beam of OFF light and dissipates heat at a position where there is no interference with other members that perform optical action, and it is possible to easily control the temperature around the color prism 311.

Here, the reflection film 326 can obtain a mirror effect by forming a multilayer film, for example, but a metal mirror of aluminum, silver, or the like, can also provide a similar effect. However, heat absorption in the reflection film 326 may partially cause thermal distortion in the color prism 311, and thus, caution is required when light output to be handled is large.

Furthermore, the prism configuration, the arrangement of the optical paths of the color light, the setting of the air gap, and the like, are merely examples, and are not limited to the above-described configurations.

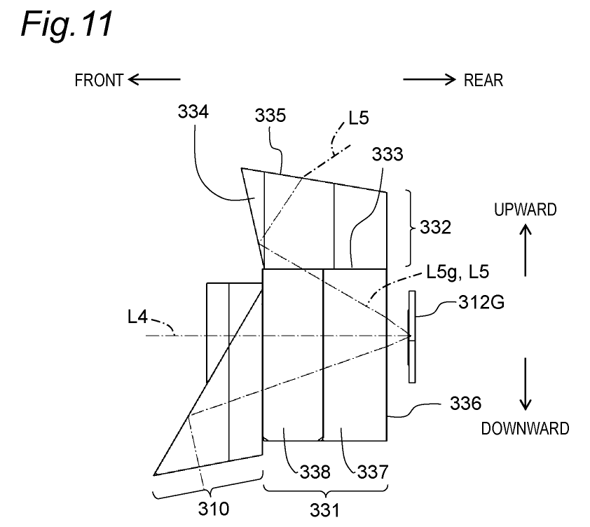

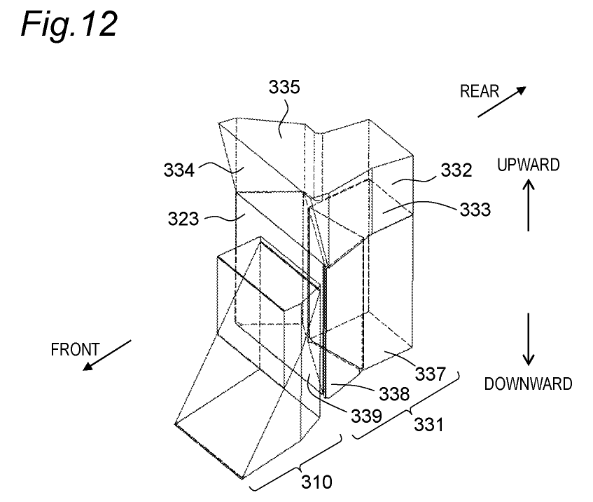

FIGS. 11 and 12 illustrate a first modification of the second embodiment. The color prism 331 is disposed with a gap from the total reflection prism 310. The basic configuration of the color prism 331 is the same as that of the color prism 311, but the height is set to be low, and the reflection film 326 arranged on the B prism 316 is not arranged. An OFF prism 332 made of a light transmitting material is fixed to the color prism 331 via a bonding surface 333.

Although the OFF prism 332 is similar to a shape in which the color prism 331 is extended upward, the total reflection surface 334 is inclined in a direction in which the incident angle of the OFF light increases in the OFF light incident region on which the reflection film 326 is applied in the second embodiment. For example, for convenience in FIG. 11, light in a green wavelength region will be described.

The ON light L4g reflected as the video light in the green wavelength region by the image display element 312G is guided to the projection lens without changing the above-described configuration. The OFF light L5g reflected as unnecessary light by the image display element 312G passes through the G prism facing surface 336 again, passes through the inside of the G prism 337, the R prism 338, and the B prism 339, passes through the bonding surface 333, and enters the OFF prism 332. The light is transmitted through the OFF prism 332, is incident on the total reflection surface 334, and is totally reflected.

As a result, the light is transmitted through the OFF prism 332 again, and is emitted from the top surface 335 inclined in a direction in which the incident angle of the OFF light decreases so that the incident OFF light is transmitted. In this way, similarly to the second embodiment, the OFF light can be guided in a direction in which the absorption processing can be easily performed. Here, the OFF prism 332 is attached to the color prism 331.

The OFF prism 332 itself does not generate heat as long as it is made of a material having excellent light transmittance, and thus, the OFF prism can be formed with a resin material instead of glass. As a result, not only cost can be suppressed by lowering the height of the color prism 331, but also the OFF prism 332 is not designed to have optically strict dimensions, so that it can be formed with an optical resin, or the like, to achieve low cost and light weight.

In addition, here, the total reflection surface 334 is provided on the OFF prism 332, but the total reflection surface may be formed by attaching a prism capable of implementing the same shape to the prism front surface 323 of the color prism 311 of the second embodiment.

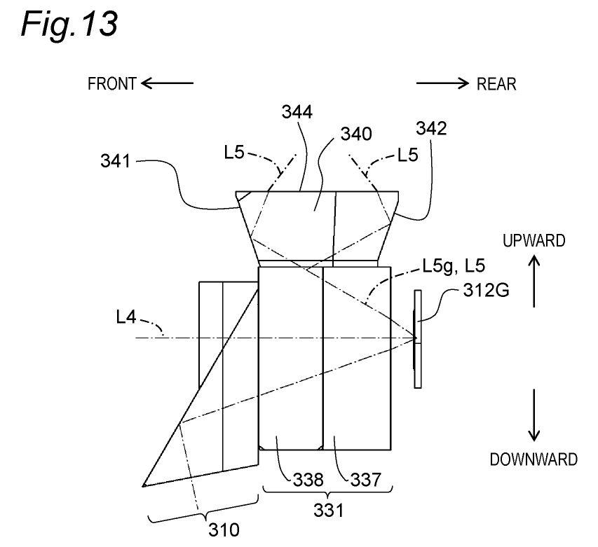

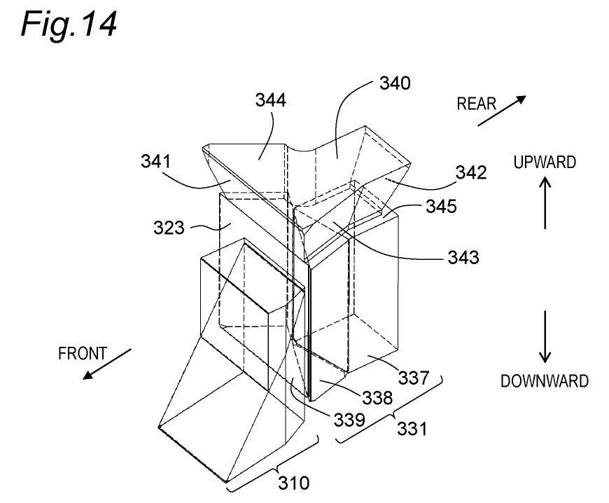

Next, a second modification of the second embodiment will be described with reference to FIGS. 13 and 14. In the second modification illustrated in FIGS. 13 and 14, the OFF prism 332 of the first modification is changed to an OFF prism 340. The OFF prism 340 is bonded to the color prism 331 in a similar manner to the first modification. In this event, in the OFF prism 340, the dichroic mirror and the air gap between the prisms forming the color prism 331 are eliminated, and thus, a portion of the OFF light leaks in the other direction instead of a surface facing the total reflection prism.

Thus, in a case where leakage light becomes a problem, the OFF prism 340 includes a total reflection surface 342 arranged in the direction of the G prism and a total reflection surface 343 arranged in the direction of the R prism in addition to the total reflection surface 341, and is configured to be able to process the leakage light through the top surface 344. Note that, in a case where the inclined portion of each total reflection surface becomes a portion protruding to the outside of the outer shape of the color prism 331 as it is, interference with a peripheral mechanism not illustrated in FIGS. 13 and 14 is concerned. Thus, a bonding range with the OFF prism 340 on the upper surface of the color prism 331 is partially limited to the inside of the outer shape of the color prism 331. Thus, as illustrated in FIG. 14, an upper surface of the color prism 331 has an exposed region 345 that is not bonded to the OFF prism 340 along a portion of the outer periphery and is exposed to air. The exposed region 345 is formed on each of the image display elements 312R, 312G, 312B except for the projection direction of the upper surface of the color prism 331.

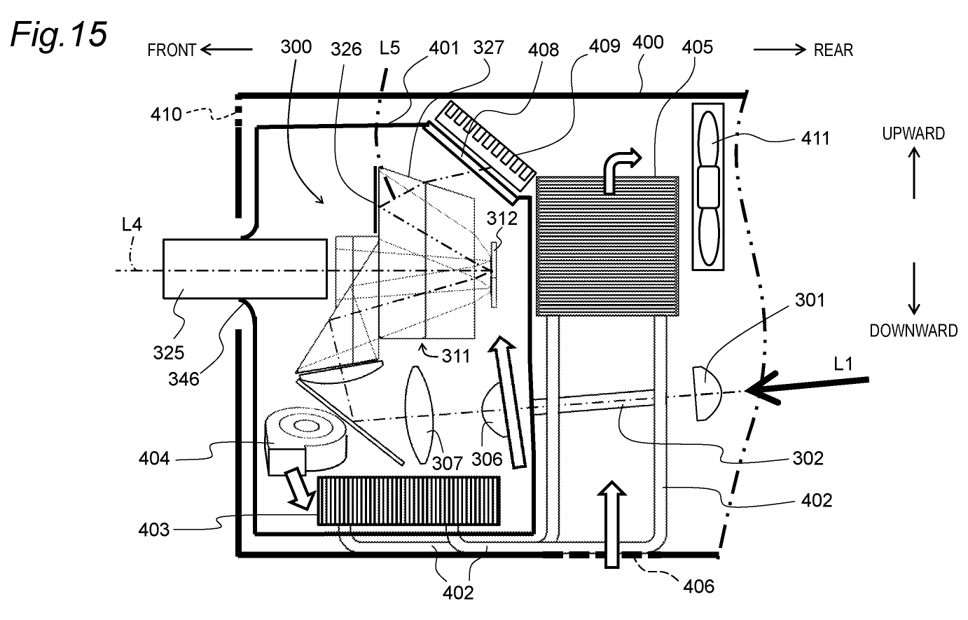

FIG. 15 partially illustrates a configuration of the projection-type video display device 3 around the image display element 312 in FIG. 8. The projection-type video display device 3 includes an exterior case 400 and a sealed casing 401 that encloses an optical configuration 300 in a front portion of the exterior case 400. A heat receiving fin 403 formed by stacking fins made of thin plates and connected to one end of the heat pipe 402, and a circulation fan 404 are disposed inside the sealed casing 401. On the other side of the heat pipe 402, that is, on the opposite side of the heat pipe 402 connected to the heat receiving fin 203, a heat radiating fin 405 formed by stacking fins made of thin plates similarly to the heat receiving fin 203 is connected.

The heat radiating fin 405 is disposed such that air from an outside air intake portion 406 in the exterior case 400 passes therethrough. In the outside air intake portion 406, a vent hole is formed in a portion of the exterior case 400. The optical configuration 300 described with reference to FIG. 8 is installed in the sealed casing 401 as illustrated in FIG. 15. The sealed casing 401 has a dustproof structure around the rod integrator 302 and the projection lens 325 such that dust does not adhere to an optical member or the image display element 312 from the outside of the sealed casing 401 by interposing a buffer material 346, or the like, having no air permeability with a wall surface of the sealed casing 401.

Here, as described with reference to FIG. 8, the OFF light from the image display element 312 is reflected by the reflection film 326, passes through the top surface 327 of the color prism 311, and is guided to the outside of the color prism 311.

A window 408 having a characteristic of transmitting the OFF light L5 is disposed at a position facing the top surface 327 of the color prism 311 of the sealed casing 401, and the OFF light L5 is transmitted through the window 408 and emitted to the outside of the sealed casing 401. Further, a light absorbing plate 409 having a characteristic of absorbing the OFF light L5 is disposed near the window 408. The light transmitted through the window 408 is absorbed by the light absorbing plate 409 and becomes heat. The light absorbing plate 409 has an uneven shape that increases a surface area for heat dissipation on a back surface opposite to a surface on which the OFF light L5 is incident.

The heat generation in the light absorbing plate 409 is outside the sealed casing 401, so that it is possible to suppress increase in the internal temperature due to the OFF light processing of the sealed casing 401. The ON light is originally emitted by the projection lens 325, and thus, it is not always necessary to expect temperature rise in the sealed casing 401, so that it is possible to change the heat receiving fin 403, the circulation fan 404, the heat pipe 402, and the heat radiating fin 405, which are a portion of the cooling device for cooling the sealed casing 401, to a small size or a heat sink having a simpler structure. As described above, according to the configuration illustrated in FIG. 15, it is possible to reduce a size and cost of a cooling member and a casing that accommodates the cooling member while maintaining reliability of the optical member and the image display element.

Note that the OFF light L5 is emitted from the top surface 327 of the color prism 311 while spreading, and thus, as the distance between the window 408 and the top surface 327 of the color prism 311 becomes closer, the sizes of the window 408 and the light absorbing plate 409 arranged in the vicinity of the window 408 can be made smaller. In addition, the window 408 may be formed by applying antireflection coating, or the like, to glass or a transparent resin and fitting and fixing the glass or the transparent resin into the wall of the sealed casing 401 without any gap, or by molding the glass or the transparent resin into two colors with the sealed casing 401.

In addition, the light absorbing plate 409 is made of aluminum or copper having good thermal conductivity, and the light incident surface may be subjected to blacking processing, or the like, for suppressing reflection together with light absorption. In addition, in a case where an amount of light to be absorbed is large, air may be sent to an uneven portion on a back surface by a fan, or the like, to increase the heat dissipation effect. Furthermore, the light absorbing plate 409 can be also applied to a vapor chamber of a thin heat pipe, a cold plate through which a refrigerant liquid flows, and the like. In a case where heat is transferred and cooling processing is performed in other portions, the above-described uneven portion is not necessarily required.

Further, if an intake port 410 is further provided in the exterior case 400 so that the fan 411 can take in the outside air, and the light absorbing plate 409 is disposed between flow paths of the intake port 410 and the fan 411, stronger cooling can be performed.

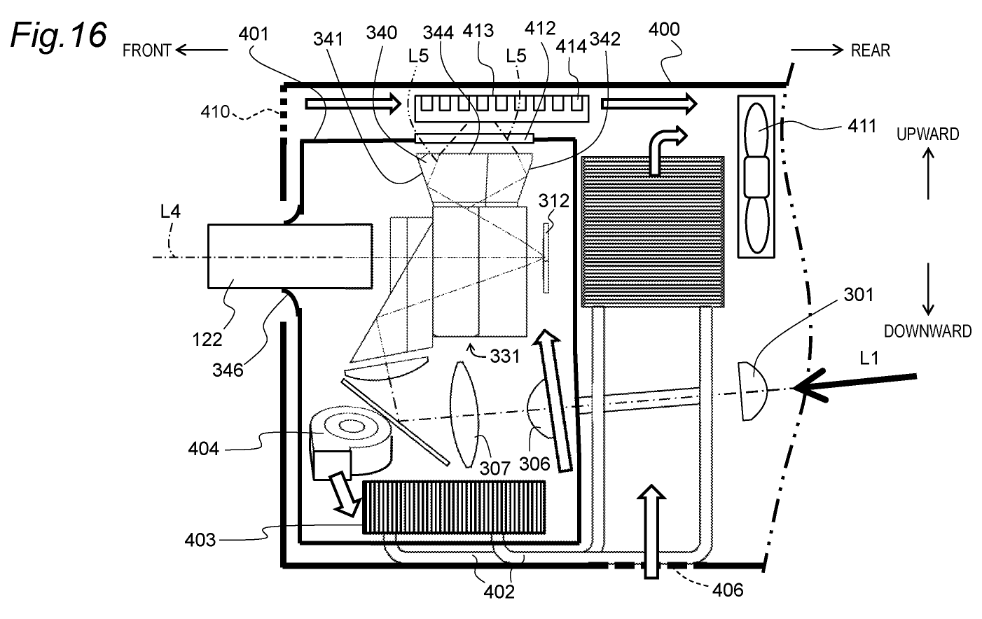

FIG. 16 illustrates a configuration in which the optical configuration illustrated in FIGS. 12 to 14 is replaced with FIG. 15, and description of a portion overlapping with the above description will be omitted. In a second modification of the second embodiment illustrated in FIG. 16, the OFF prism 340 is fixed onto the color prism 331 with a light transmissive adhesive. The OFF light L5 incident on the OFF prism 340 from the color prism 331 is reflected by the total reflection surface 341, a portion of the OFF light L5 is directly transmitted through the top surface 344, a portion of the OFF light L5 is incident on the total reflection surface 342 or the total reflection surface 343, reflected, and transmitted through the top surface 344.

The OFF light L5 transmitted through the top surface 344 of the OFF prism 340 is incident on a window 412 and transmitted through the window 412. Further, a light absorbing plate 413 that is disposed near the window 412 and has a characteristic of absorbing the OFF light L5 is disposed. Similarly to the light absorbing plate 409, the light absorbing plate 413 has an uneven shape 414 that expands a surface area on a back surface thereof for heat dissipation. In this way, the light absorbing plate 413 can absorb the OFF light L5 in a similar manner as described above, but the top surface 344 of the OFF prism 340 is parallel to the top surface of the exterior case 400 of the projection-type video display device 3, and thus, it is not necessary to increase an interval between the window 412, the light absorbing plate 413, and the exterior case 400 more than necessary. The light absorbing plate 413 is not limited to a rectangle as illustrated in FIG. 16 and the processing is not limited to the absorption processing described above, and any application is possible as long as the OFF light L5 can be absorbed.

Further, the heat pipe 402 is used for cooling the inside of the sealed casing 401. However, the present invention is not limited to this configuration. In consideration of an amount of heat to be processed, installability, cost, and the like, it is also possible to easily exchange heat between the inside air and the outside air on the front and back of a heat conduction member such as the heat sink, and a water cooling system, or the like, can be selected as long as a degree of freedom in installability is required while increasing cooling performance. Further, in the water cooling system, the image display element 312 can also be cooled as necessary.

### [2-2. Effects, and the like]

As described above, the projection-type video display device 3 of the second embodiment includes the light source 10, the plurality of image display elements 312R, 312G, 312B that modulates light from the light source 10 into video light, the projection lens 122 that projects the video light, the color prism 311 that guides the light source light L1 from the light source 10 to the plurality of image display elements 312R, 312G, 312B and guides light modulated by the image display elements 312R, 312G, 312B to the projection lens 122, and the total reflection prism 310 that is disposed between the projection lens 122 and the color prism 311 and guides the light source light L1 from the light source 10 to the color prism 311. The image display elements 312R, 312G, 312B generate ON light modulated as video light by being reflected at a first angle and the OFF light L5 as unnecessary light by being reflected at a second angle. The color prism 311 includes the B-prism front surface 323 on which the reflection film 326 is formed as a reflection surface that guides the OFF light in the opposite direction to the projection lens 122 with respect to the B-prism front surface 323 facing the total reflection prism 310.

The region on the B-prism front surface 323 where the reflection film 326 is formed acts as a reflection surface of the OFF light, and the OFF light emitted from the image display element 312G is incident on the reflection film 326 on the B-prism front surface 323, is reflected by the reflection film 326, and is guided in the opposite direction to the projection lens 325 with respect to the B-prism front surface 323. As a result, it is possible to reduce temperature rise of the space in the vicinity of the prism 314 having the ON light emitting surface due to the OFF light, and it is possible to reduce damage due to heat of the device such as the shutter. It is therefore possible to reduce thermal influence of the OFF light emitted from the image display element 312G on the periphery of the ON light incident side of the projection lens 325, to guide the OFF light to a position where heat dissipation processing can be easily performed, and to enable absorption processing, and it is possible to provide the projection-type video display device 3 that achieves high reliability. In addition, it is not necessary to add a dedicated prism for reflecting unnecessary light between the color prism 311 and the image display element 312, and it is not necessary to provide an air layer between the dedicated prism and the color prism 311. It is therefore possible to suppress increase in size of the color prism 311 disposed between the projection lens 325 and the image display element 312, and it is possible to suppress increase in size of the optical configuration 300. Furthermore, by preventing increase in the air layer on the optical path of the ON light, it is possible to prevent increase in adverse effects such as flare of the projected image.

As described above, the above embodiments have been described as examples of the technique in the present disclosure. For this purpose, the accompanying drawings and the detailed description have been provided. Thus, the components described in the accompanying drawings and the detailed description may include not only components essential for solving the problem but also components that are not essential for solving the problem in order to illustrate the above technique. Thus, it should not be immediately recognized that these non-essential components are essential on the basis of the fact that these non-essential components are described in the accompanying drawings and the detailed description.

In addition, while the present disclosure has been sufficiently described in association with the embodiments with reference to the accompanying drawings, the above embodiments are intended to illustrate the technique in the present disclosure, and thus, various changes, replacements, additions, omissions, and the like, can be made within the scope of the claims or equivalents thereof. In addition, a new embodiment can be made by combining the components described in the above embodiments. Such modifications and embodiments obtained by appropriately combining the technical means disclosed in the different embodiments are also included in the technical scope of the present disclosure.

### (Outline of Embodiments)

(1) A projection-type video display device of the present disclosure includes: a light source; an image display element that generates ON light modulated as video light by reflecting source light from the light source at a first angle and OFF light as unnecessary light by reflecting the source light at a second angle; a projection lens that projects the ON light; a reflection prism that guides the source light to the image display element and guides the ON light modulated by the image display element to the projection lens; and a reflection surface that guides the OFF light in an opposite direction to the projection lens with respect to an ON light emitting surface to the projection lens included in the reflection prism.

The OFF light emitted from the image display element is incident on the reflection surface, is then reflected by the reflection surface, and is guided in the opposite direction to the projection lens with respect to the ON light emitting surface included in the reflection prism. As a result, it is possible to reduce temperature rise of a space in the vicinity of the ON light emitting surface due to the OFF light. It is therefore possible to reduce thermal influence of the OFF light emitted from the image display element on the periphery of the projection lens on the ON light incident side, to guide the OFF light to a position where heat dissipation processing can be easily performed, and to enable absorption processing, and to provide the projection-type video display device that achieves high reliability.

(2) In the projection-type video display device according to (1), the reflection surface is configured such that a member or a shape reflecting the OFF light different from a region where the ON light is emitted on an ON light emitting surface is provided in an incident region of the OFF light not overlapping an incident region of the ON light on the ON light emitting surface or an incident region of the OFF light in an extension portion extending from the ON light emitting surface.

(3) In the projection-type video display device according to (1) or (2), the reflection prism is configured such that the OFF light reflected by the reflection surface is emitted from the reflection prism in a direction intersecting with the ON light.

(4) The projection-type video display device according to any one of (1) to (3), includes a light guide member that guides the OFF light in an opposite direction to the projection lens, the light guide member being bonded to the reflection prism outside an optical path of the ON light of the reflection prism, and the reflection surface is included in the light guide member.

(5) In the projection-type video display device according to any one of (1) to (4), the reflection prism includes a first light emitting prism that emits the ON light to the projection lens, and a second light emitting prism that emits the OFF light in an opposite direction to the projection lens, the second light emitting prism includes a reflection surface, and the reflection surface has an inclination inclined in a direction of increasing an incident angle with respect to the incident OFF light, and the OFF light is totally reflected by the inclination.

(6) In the projection-type video display device according to (5), a material of the second light emitting prism is a transparent material having a refractive index the same as or lower than a refractive index of a material of the first light emitting prism.

(7) The projection-type video display device according to any one of (1) to (6) includes a sealed casing that includes the image display element, the reflection prism, and an incident side portion of the ON light in the projection lens, and in the sealed casing, at least an incident region of the OFF light emitted from the reflection prism has a characteristic of transmitting the OFF light.

(8) The projection-type video display device according to (7) includes a light absorbing member disposed outside the sealed casing, and the light absorbing member is disposed on an optical path of the OFF light emitted from the reflection prism in the opposite direction to the projection lens with respect to the reflection surface.

(9) A projection-type video display device according to another aspect of the present disclosure includes a light source, a plurality of image display elements that modulates light from the light source into video light, a projection lens that projects the video light, a color prism that guides the light from the light source to the plurality of image display elements and guides the light modulated by the image display elements to the projection lens, and a reflection prism that is disposed between the projection lens and the color prism and guides the light from the light source to the color prism. The image display elements generate ON light modulated as video light by being reflected at a first angle and OFF light as unnecessary light by being reflected at a second angle. A reflection surface that guides the OFF light in an opposite direction to the projection lens with respect to a surface of the color prism facing the reflection prism is provided.

The OFF light emitted from the image display elements is incident on the reflection surface, is then reflected by the reflection surface, and is guided in the opposite direction to the projection lens with respect to the surface facing the reflection prism in the color prism. As a result, it is possible to reduce temperature rise of a space in the vicinity of the surface facing the reflection prism in the color prism due to the OFF light. It is therefore possible to reduce thermal influence of the OFF light emitted from the image display elements on the periphery of the projection lens on the ON light incident side, to guide the OFF light to a position where heat dissipation processing can be easily performed, and to enable absorption processing, and to provide the projection-type video display device that achieves high reliability.

(10) In the projection-type video display device according to (9), the reflection surface is configured such that a member or a shape reflecting the OFF light different from a region where the ON light is emitted on a surface facing the reflection prism is provided in an incident region of the OFF light on the surface facing the reflection prism or an incident region of the OFF light on an extension portion of the surface facing the reflection prism.

(11) In the projection-type video display device according to (9) or (10), the reflection prism is configured such that the OFF light reflected by the reflection surface is emitted from the reflection prism in a direction intersecting with the ON light.

(12) The projection-type video display device according to any one of (9) to (11) includes a light guide member that guides the OFF light to an opposite direction to the projection lens, the light guide member being bonded to the reflection prism outside an optical path of the ON light of the reflection prism, and the reflection surface is included in the light guide member.

(13) In the projection-type video display device of any one of (9) to (12), the reflection prism includes a first light emitting prism that emits the ON light to the projection lens, and a second light emitting prism that emits the OFF light in an opposite direction to the projection lens. The second light emitting prism includes a reflection surface, and the reflection surface has an inclination inclined in a direction of increasing an incident angle with respect to the incident OFF light, and the OFF light is totally reflected by the inclination.

(14) In the projection-type video display device according to (13), a material of the second light emitting prism is a transparent material having a refractive index the same as or lower than a refractive index of a material of the first light emitting prism.

(15) The projection-type video display device according to any one of (9) to (14) includes a sealed casing that includes the image display elements, the reflection prism, and an incident side portion of the ON light in the projection lens. In the sealed casing, at least the incident region of the OFF light emitted from the reflection prism has a characteristic of transmitting the OFF light.

(16) The projection-type video display device according to (15) includes a light absorbing member disposed outside the sealed casing, the light absorbing member is disposed between a window provided in the sealed casing and transmitting OFF light and an exterior case accommodating the sealed casing, and the window and the light absorbing member are disposed on an optical path of the OFF light emitted from the reflection prism in an opposite direction to the projection lens with respect to the reflection surface.

The present disclosure can be used as a cooling structure of a projection-type video display device including a reflective image display element.

### EXPLANATIONS OF LETTERS OR NUMERALS

1, 3 Projection-type video display device

100, 300 Optical configuration

101, 301 Condenser lens

102, 302 Rod integrator

103, 303 Incident surface of rod integrator

104 Color wheel unit

105 Motor

106 Hub of motor

107a, 107b, 107c Color selection filter

108, 304 Light emitting surface of rod integrator

109, 305 Relay optical system

110, 111, 112, 306, 307, 309 Lens

113, 308 Mirror

114, 114A, 114B, 114C, 310 Total reflection prism

115, 312, 312R, 312G, 312B Image display element

116, 313 prism

117, 314 prism

118 Gap of total reflection prism

119 First surface

120 Second surface

121, 315 Third surface

122, 325 Projection lens

122A Projection lens incident side opening

123 First surface

124 Second surface

125, 326 Reflection film

126 Third surface

127 Shutter

128 ON light incident region

129 OFF light incident region

130, 209, 409, 413 Light absorbing plate

131 Convex lens

132 Light emitting surface of convex lens

133, 138 First light emitting prism

134, 139, 140 Second light emitting prism

135, 141, 333 Bonding surface

136, 143 Light emitting surface facing projection lens of first light emitting prism

142 Light emitting surface of second light emitting prism

137 Inclined surface of second light emitting prism

144 Top surface of second light emitting prism

200, 400 Exterior case

201, 401 Sealed casing

202, 402 Heat pipe

203, 403 Heat receiving fin

204, 404 Circulation fan

205, 405 Heat radiating fin

206, 406 Outside air intake portion

208, 408, 412 Window

311, 331 Color prism

316, 339 B prism

317, 338 R prism

318, 337 G prism

319 Light selection surface of B prism

320 Blue reflection dichroic mirror

321 Red reflection dichroic mirror

322, 334, 341 Total reflection surface

323 B prism front surface

324 B prism facing surface

327 Top surface of color prism

328 Total reflection surface of R prism

329 R prism facing surface

330, 336 G prism facing surface

332, 340 OFF prism

335, 344 Top surface of OFF prism

342 Total reflection surface arranged in the direction of the G prism

343 Total reflection surface arranged in the direction of the R prism

410 Intake port

411 Fan

414 Uneven shape

L1 Light source light

L2, L4 ON light

L3, L5, L7 OFF light

What is claimed is:

1. A projection-type video display device comprising:
a light source;
an image display element that generates ON light modulated as video light by reflecting source light from the light source at a first angle and OFF light as unnecessary light by reflecting the source light at a second angle;
a projection lens that projects the ON light;
a reflection prism that guides the source light to the image display element and guides the ON light modulated by the image display element to the projection lens; and
a reflection surface that guides the OFF light in an opposite direction to the projection lens with respect to an ON light emitting surface to the projection lens included in the reflection prism.

2. The projection-type video display device according to claim 1, wherein the reflection surface is configured such that a member or a shape reflecting the OFF light different from a region where the ON light is emitted on an ON light emitting surface is provided in an incident region of the OFF light not overlapping an incident region of the ON light on the ON light emitting surface or an incident region of the OFF light in an extension portion extending from the ON light emitting surface.

3. The projection-type video display device according to claim 2, wherein the reflection prism is configured such that the OFF light reflected by the reflection surface is emitted from the reflection prism in a direction intersecting with the ON light.

4. The projection-type video display device according to claim 1, comprising a light guide member that guides the OFF light in an opposite direction to the projection lens, the light guide member being bonded to the reflection prism outside an optical path of the ON light of the reflection prism,
wherein the reflection surface is included in the light guide member.

5. The projection-type video display device according to claim 1, wherein
the reflection prism includes a first light emitting prism that emits the ON light to the projection lens, and a second light emitting prism that emits the OFF light in an opposite direction to the projection lens,
the second light emitting prism includes a reflection surface, and
the reflection surface has an inclination inclined in a direction of increasing an incident angle with respect to the incident OFF light, and the OFF light is reflected by the inclination.

6. The projection-type video display device according to claim 5, wherein a material of the second light emitting prism is a transparent material having a refractive index same as or lower than a refractive index of a material of the first light emitting prism.

7. The projection-type video display device according to claim 1, comprising a sealed casing that includes the image display element, the reflection prism, and an incident side portion of the ON light in the projection lens,
wherein in the sealed casing, at least an incident region of the OFF light emitted from the reflection prism has a characteristic of transmitting the OFF light.

8. The projection-type video display device according to claim 7, comprising a light absorbing member disposed outside the sealed casing, wherein
the light absorbing member is disposed between a window provided in the sealed casing and transmitting the OFF light and an exterior case accommodating the sealed casing, and
the window and the light absorbing member are disposed on an optical path of the OFF light emitted from the reflection prism in an opposite direction to the projection lens with respect to the reflection surface.

9. A projection-type video display device comprising:
a light source;
a plurality of image display elements that modulates light from the light source into video light;
a projection lens that projects the video light;
a color prism that guides the light from the light source to the plurality of image display elements and guides the light modulated by the image display elements to the projection lens; and
a reflection prism that is disposed between the projection lens and the color prism and guides the light from the light source to the color prism, wherein
the image display elements generate ON light modulated as video light by being reflected at a first angle and OFF light as unnecessary light by being reflected at a second angle, and
a reflection surface that guides the OFF light in an opposite direction to the projection lens with respect to a surface of the color prism facing the reflection prism is provided.

10. The projection-type video display device according to claim 9, wherein the reflection surface is configured such that a member or a shape reflecting the OFF light different from a region where the ON light is emitted on a surface facing the reflection prism is provided in an incident region of the OFF light not overlapping an incident region of the ON light on a surface facing the reflection prism or an incident region of the OFF light in an extension portion extending from a surface facing the reflection prism.

11. The projection-type video display device according to claim 10, wherein the reflection prism is configured such that the OFF light reflected by the reflection surface is emitted from the reflection prism in a direction intersecting with the ON light.

12. The projection-type video display device according to claim 9, comprising a light guide member that guides the OFF light in an opposite direction to the projection lens, the light guide member being bonded to the reflection prism outside an optical path of the ON light of the reflection prism,
wherein the reflection surface is included in the light guide member.

13. The projection-type video display device according to claim 9, wherein
the reflection prism includes a first light emitting prism that emits the ON light to the projection lens, and a second light emitting prism that emits the OFF light in an opposite direction to the projection lens,
the second light emitting prism includes the reflection surface, and
the reflection surface has an inclination inclined in a direction of increasing an incident angle with respect to the incident OFF light, and the OFF light is totally reflected by the inclination.

14. The projection-type video display device according to claim 13, wherein a material of the second light emitting prism is a transparent material having a refractive index same as or lower than a refractive index of a material of the first light emitting prism.

15. The projection-type video display device according to claim 9, comprising a sealed casing that includes the image display elements, the reflection prism, and an incident side portion of the ON light in the projection lens,
wherein in the sealed casing, at least an incident region of the OFF light emitted from the reflection prism has a characteristic of transmitting the OFF light.

16. The projection-type video display device according to claim 15, comprising a light absorbing member disposed outside the sealed casing, wherein
the light absorbing member is disposed between a window provided in the sealed casing and transmitting the OFF light and an exterior case accommodating the sealed casing, and
the window and the light absorbing member are disposed on an optical path of the OFF light emitted from the reflection prism in an opposite direction to the projection lens with respect to the reflection surface.
